(19) United States
(12) Patent Application Publication
(10) Pub. No.: US 2018/0371219 A1
(43) Pub. Date: Dec. 27, 2018

(54) BLOWN POLYOLEFIN FILMS

(71) Applicant: BASELL POLYOLEFINE GmbH, WESSELING (DE)

(72) Inventors: MICHELE GRAZZI, FERRARA (IT); CLAUDIO CAVALIERI, FERRARA (IT)

(73) Assignee: BASELL POLYOLEFINE GmbH, WESSELING (DE)

(21) Appl. No.: 15/778,979

(22) PCT Filed: Nov. 8, 2016
(86) PCT No.: PCT/EP2016/077018

§ 371 Date: May 24, 2018

(30) Foreign Application Priority Data
Nov. 24, 2015 (EP) 15195966.5

(51) Int. Cl. C08L 23/08; C08J 5/18; B32B 27/32; B32B 27/08; B65D 65/38

(52) U.S. Cl. CPC C08L 23/0815; C08J 5/18; B32B 27/32; B32B 27/08; B65D 65/38; B32B 2439/70; C08J 2423/08; C08L 2203/16; C08L 2205/025; C08L 2314/02; C08J 2323/08

(57) ABSTRACT

A blown film made from or containing a polyolefin composition (I) made from or containing:
A) from about 40 to about 75 wt. %, based upon the total weight of the polyolefin composition, of a polyethylene having a density of about 0.920 to about 0.940 g/cm³ and a fraction soluble in xylene (XS_{A}) of less than about 10% wt. %; and
B) from about 25 to about 60 wt. %, based upon the total weight of the polyolefin composition, of a copolymer of ethylene with one or more comonomers selected from α-olefins having formula HC₂═CHR^{I}, where R^{I} is an alkyl radical, linear or branched, having from 1 to 8 carbon atoms, made from or containing from about 50 to about 70 wt. % of ethylene and having a fraction soluble in xylene (XS_{B}) of at least 50 wt. %.

### FIELD OF THE INVENTION

In general, the present disclosure relates to the field of chemistry. More specifically, the present disclosure relates to polymer chemistry. In particular, the present disclosure relates to a polyolefin composition made from or containing a polyethylene having a density of about 0.920 to about 0.940 g/cm³ and an ethylene copolymer and blown film made therefrom.

### BACKGROUND OF THE INVENTION

Blown films are useful in industry packaging, consumer packaging, bags and sacks.

Blown films have a tubular shape which is useful in bags for urban refuse, bags for industrial materials, bags for frozen foods, and carrier bags. The tubular structure also permits a reduced number of welding joints for formation of the bag as compared to the number of welding joints for flat films, thereby providing a simpler process. Moreover, the blown-film technique permits tubular films of various sizes, thereby avoiding trimming of the films.

It is believed that blown film orientation can be balanced between film extrusion and film cross directions by selecting processing parameters such as blow-up ratio, draw-down ratio, air cooling intensity and distribution and extrusion speed.

In contrast to cast films, blown films have homogeneous mechanical properties in cross direction.

It is also believed that blown film gauge variation in transverse direction can be distributed and equalized with reversing haul-off devices, thereby yielding cylindrical reels.

Blown films exhibit constant properties and film thickness in transverse direction. As such, blown films do not require edge trimming.

### SUMMARY OF THE INVENTION

In a general embodiment, the present disclosure provides a blown film made from or containing a polyolefin composition (I) made from or containing:
A) from about 40 to about 75 weight percent (“wt. %”), based upon the total weight of the polyolefin composition, of a polyethylene having a density of about 0.920 to about 0.940 g/cm³ and a fraction soluble in xylene (XS_{A}) of less than about 10 wt. %, based upon the weight of the polyethylene, the polyethylene made from or containing ethylene and one or more comonomers selected from α-olefins having formula CH₂═CHR, wherein R is an alkyl radical, linear or branched, having from 1 to 10 carbon atoms; and
B) from about 25 to about 60 wt. %, based upon the total weight of the polyolefin composition, of a copolymer of ethylene with one or more comonomers selected from α-olefins having formula HC₂═CHR^{I}, where R^{I} is an alkyl radical, linear or branched, having from 1 to 8 carbon atoms, made from or containing from about 50 to about 70 wt. %, based upon the weight of the copolymer of ethylene, of ethylene and having a fraction soluble in xylene (XS_{B}) of at least 50 wt. %, based upon the weight of the copolymer of ethylene.

In some embodiments, Component A) is present in an amount from about 55 to about 75 wt. %, based upon the total weight of the polyolefin composition. In some embodiments, Component B) is present in an amount from about 25 to about 45 wt. %. Component B) is more soluble in xylene than component A).

The blown film can be monolayer or multilayer.

### DETAILED DESCRIPTION OF THE INVENTION

### Definitions and Test Methods

In the present description, “room temperature” means a temperature of about 25° C.

Solubility in xylene (XS) was determined by the following procedure: 2.5 g of polymer and 250 ml of xylene were introduced in a glass flask equipped with a refrigerator and a magnetic stirrer. The temperature was raised in 30 minutes up to the boiling point of the solvent. The solution was kept under reflux and stirring for further 30 minutes. The closed flask was then left to reach 100° C. (heating switched off) and then the flask was placed in a thermostatic water bath at 25° C. for 30 minutes. The solid formed was filtered on quick filtering paper. 100 ml of the filtered liquid was poured in a pre-weighed aluminum container, which was heated on a heating plate under nitrogen flow to remove the solvent by evaporation. The container was then kept in an oven at 80° C. under vacuum until constant weight was obtained. The weight percentage of polymer soluble in xylene at room temperature was then calculated.

Density was determined according to ISO 1183 at 23° C.

Unless otherwise noted, Melt Flow Rate (MFR) was determined according to ISO 1133 at 230° C. with a load of 2.16 kg.

Melting temperature was determined by differential scanning calorimetry (DSC) according to ISO 11357-3. A sample weighing 6±1 mg was heated to 200±1° C. at a rate of 20° C./min and kept at 200±1° C. for 2 minutes in nitrogen stream and was then cooled at a rate of 20° C./min to 40±2° C., and then kept at this temperature for 2 min. Then, the sample was again melted at a temperature rise rate of 20° C./min up to 200° C.±1. The melting scan was recorded, a thermogram was obtained, and, from the thermogram, temperatures corresponding to peaks were read. The temperature corresponding to the most intense melting peak recorded during the second fusion was taken as the melting temperature.

Intrinsic Viscosity (I.V.) was determined in tetrahydronaphthalene at 135° C. The sample was dissolved in tetrahydronaphthalene at 135° C. and then poured into a capillary viscometer. The viscometer tube (Ubbelohde type) was surrounded by a cylindrical glass jacket; allowing temperature control with a circulating thermostated liquid. The downward passage of the meniscus was timed by a photoelectric device. The passage of the meniscus in front of the upper lamp started the counter which had a quartz crystal oscillator. The meniscus stopped the counter as the meniscus passed the lower lamp and the efflux time was registered. This efflux time was converted into a value of intrinsic viscosity through Huggins' equation (Huggins, M. L., J. Am. Chem. Soc., 1942, 64, 2716) based on the flow time of the pure solvent at the same experimental conditions (same viscometer and same temperature). A single polymer solution was used to determine the I.V. [η].

Propylene and butene-1 contents were determined by IR spectroscopy.

The following measurements were used to calculate the propylene content:
a) Area (ANIR) of the combination absorption bands between 4482 and 3950 cm⁻¹ which was used for spectrometric normalization of film thickness.
b) Area (A971) of the absorption band due to propylene sequences in the range 986-952 cm⁻¹, omitting area beneath a baseline drawn between the endpoints.

The ratio A971/ANIR was calibrated by analyzing reference compositions.

The following measurements were used to calculate the 1-butene content:

Area (ANIR) of the combination absorption bands between 4482 and 3950 cm′ which was used for spectrometric normalization of sample thickness.

Area (Ac4) of the absorption band due to ethyl branches from 1-butene propylene sequences in the range 781-750 cm′, omitting the area beneath a baseline drawn between the endpoints.

The ratio Ac4/ANIR was calibrated by analyzing reference compositions.

Flexural Modulus: ISO 178, measured on 4 mm compression molded sheets 24 hours after molding. Compression molded specimens were prepared according to ISO 293 and ISO 1872-2.

Tensile strength and elongation at yield: (ISO 527-3; 50 mm/min), measured on 4 mm injection molded specimens 24 hours after injection.

Tensile strength at and elongation at break: (ISO 527-3; 50 mm/min), measured on 4 mm injection molded specimens 24 hours after injection.

Softening Vicat temperature: (ISO 306) measured on 4 mm injection molded specimens 24 hours after injection.

H.D.T. at 0.455 MPa load: (ISO 75) measured on 4 mm injection molded specimens 24 hours after injection.

The polyethylene component A), having a density of about 0.920 to about 0.940 g/cm³, is a copolymer of ethylene with one or more comonomers selected from α-olefins having formula CH₂═CHR, wherein R is an alkyl radical, linear or branched, having from 1 to 10 carbon atoms. In some embodiments, the α-olefins are selected from the group consisting of propylene, butene-1, pentene-1, 4-methylpentene-1, hexene-1, octene-1 and decene-1.

In some embodiments, the polyolefin composition (I) is made from or contains from about 60 to about 70 wt. %, based upon the total weight of the polyolefin composition, of component A), and from about 30 to about 40 wt. %, based upon the total weight of the polyolefin composition, of component B).

In some embodiments, the total amount of α-olefin comonomer in polyethylene component A) is from about 4 to about 15 wt. %, based upon the weight of polyethylene component A); alternatively from about 6 to about 12 wt. %.

In some embodiments, the α-olefin comonomer in polyethylene component A) is propylene, butene-1, or a mixture of propylene and butene-1.

In some embodiments, the polyethylene component A) is made from or contains from about 2 to about 5 wt. %, based upon the weight of polyethylene component A), of propylene and from about 4 to about 7 wt. % of butene-1, based upon the weight of polyethylene component A).

In some embodiments, the polyethylene component A) has a solubility in xylene (XS_{A}) at 25° C. of less than about 10 wt. %, based upon the weight of polyethylene component A), alternatively of less than about 8 wt. %, alternatively in the range from about 1 to about 10 wt. %, alternatively in the range from about 1 to about 8 wt. %.

The ethylene copolymer of component B) is a copolymer of ethylene with one or more comonomers selected from α-olefins having formula HC₂═CHR^{I}, where R^{I} is an alkyl radical, linear or branched, having from 1 to 8 carbon atoms.

In some embodiments, the α-olefins are selected from the group consisting of propylene, butene-1, pentene-1, 4-methylpentene-1, hexene-1, octene-1 and decene-1.

In some embodiments, the ethylene copolymer of component B) is a copolymer of ethylene with propylene. In some embodiments, the ethylene copolymer of component B) is made from or contains from about 35 to about 45 wt. %, based upon the weight of the ethylene copolymer, of propylene and from about 55 to about 75 wt. % of ethylene, based upon the weight of the ethylene copolymer.

In some embodiments, the ethylene copolymer of component B) has a fraction soluble in xylene (XS_{B}) of at least about 50 wt. %, based upon the weight of the ethylene copolymer, alternatively from about 50 to about 95 wt. %, alternatively from about 70 to about 95 wt. %.

In some embodiments, the intrinsic viscosity [q] of the XS_{B} fraction is about 2 dl/g, alternatively from about 2 to about 3.5 dl/g.

In some embodiments, the polyolefin composition (I) has a melting peak at a temperature Tm of about 120° C. or higher, alternatively from about 120° C. to about 130° C., measured by Differential Scanning Calorimetry with a heating rate of 20° C. per minute.

In some embodiments, the melt flow rate (MFR) of the polyolefin composition (I) is from about 0.3 to about 5 g/10 min., alternatively from about 0.5 to about 3 g/10 min., determined according to ISO 1133 at 230° C. with a load of 2.16 kg.

In some embodiments, the polyolefin composition (I) has at least one of the following additional features:
a MFR value of the polyethylene component A), determined according to ISO 1133 at 230° C. with a load of 2.16 kg, of from about 1 to about 15 g/10 min.;
an ethylene content, determined on the total amount of A)+B), of about 70 to about 95% by weight, alternatively of about 75 to about 90% by weight;
an amount of total fraction XS_{TOT} soluble in xylene at 25° C., determined by extraction carried out on the total amount of A)+B), of about 20% to about 50% by weight, alternatively of about 30 to about 40% by weight;
an intrinsic viscosity [q] of the XS_{TOT} fraction of about 1.8 dl/g or more, alternatively from about 1.8 to about 3.0 dl/g;

a flexural modulus value of less than about 260 MPa, alternatively from about 90 to less than about 260 MPa, alternatively from about 90 to about 230 MPa. In some embodiments, the polyolefin composition (I) is prepared by a sequential polymerization process, including at least two sequential steps, wherein components A) and B) are prepared in separate subsequent steps, by operating in each step, except the first step, in the presence of the polymer formed and the catalyst used in the preceding step. The catalyst is added in the first step and remains active for the subsequent steps.

In some embodiments, the polymerization process is (a) continuous or batch-type and (b) carried out in a liquid phase, in a gas phase, or by mixed liquid-gas techniques. In some embodiments, the liquid phase is in the presence of inert diluent.

In some embodiments, the polymerization temperature is from about 50 to about 100° C. In some embodiments, the pressure is atmospheric or higher.

In some embodiments, the molecular weight is regulated. In some embodiments, regulation of the molecular weight is carried out by hydrogen.

In some embodiments, polymerization is carried out in the presence of a Ziegler-Natta catalyst. In some embodiments, the Ziegler-Natta catalyst is made from or contains the product of the reaction of an organometallic compound of Group 1, 2 or 13 of the Periodic Table of Elements with a transition metal compound of Groups 4 to 10 of the Periodic Table of Elements (new notation). In some embodiments, the transition metal compound is selected among the compounds of Ti, V, Zr, Cr and Hf. In some embodiments, the transition metal compound is supported on active MgCl₂.

In some embodiments, the catalysts are made from or contain the product of the reaction of the organometallic compound of Group 1, 2 or 13 of the Periodic Table of Elements, with a solid catalyst component made from or containing a Ti compound and an electron donor compound supported on active MgCl₂.

In some embodiments, the organometallic compounds are aluminum alkyl compounds.

In some embodiments, the polyolefin composition (I) is obtainable by using a Ziegler-Natta catalyst, alternatively a Ziegler-Natta catalyst supported on active MgCl₂, alternatively a Ziegler-Natta catalyst made from or containing the product of reaction of:
1) a solid catalyst component made from or containing a Ti compound and an electron donor (internal electron-donor) supported on active MgCl₂;
2) an aluminum alkyl compound (cocatalyst); and, optionally,
3) an electron-donor compound (external electron-donor).

In some embodiments, the solid catalyst component (1) contains, as an electron-donor, a compound selected from the group consisting of ethers, ketones, lactones, compounds containing N, P and/or S atoms, and mono- and dicarboxylic acid esters.

In some embodiments, the catalyst is selected from the group of catalysts described in U.S. Pat. No. 4,399,054 and European Patent No. 45977, both incorporated herein by reference in their entirety.

In some embodiments, the electron-donor compounds are selected from the group consisting of phthalic acid esters and succinic acid esters. In some embodiments, the electron-donor compound is diisobutyl phthalate.

In some embodiments, the electron-donor compounds are succinic acid esters represented by the formula (I):

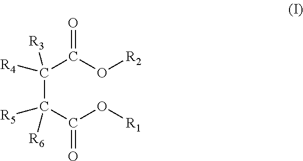

wherein the radicals R₁ and R₂, equal to or different from each other, are a C₁-C₂₀ linear or branched alkyl, alkenyl, cycloalkyl, aryl, arylalkyl or alkylaryl group, optionally containing heteroatoms; the radicals R₃ to R₆ equal to or different from each other, are hydrogen or a C₁-C₂₀ linear or branched alkyl, alkenyl, cycloalkyl, aryl, arylalkyl or alkylaryl group, optionally containing heteroatoms, and the radicals R₃ to R₆ which are joined to the same carbon atom can be linked together to form a cycle.

In some embodiments, R₁ and R₂ are C₁-C₈ alkyl, cycloalkyl, aryl, arylalkyl and alkylaryl groups. In some embodiments, R₁ and R₂ are selected from the group consisting of primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, R₃ to R₅ are hydrogen and R₆ is a branched alkyl, cycloalkyl, aryl, arylalkyl and alkylaryl radical having from 3 to 10 carbon atoms. In some embodiments, at least two radicals from R₃ to R₆ are different from hydrogen and are selected from C₁-C₂₀ linear or branched alkyl, alkenyl, cycloalkyl, aryl, arylalkyl or alkylaryl group, optionally containing heteroatoms. In some embodiments, the two radicals different from hydrogen are linked to the same carbon atom. In some embodiments, at least two radicals different from hydrogen are linked to different carbon atoms. In some embodiments, the two radicals are R₃ and R₅. In some embodiments, the two radicals are R₄ and R₆.

In some embodiments, the electron-donors are selected from the group of 1,3-diethers described in European Patent Application Nos. EP 0 361 493 B 1 and EP 0 728 769 B 1, incorporated herein by reference in their entirety.

In some embodiments, cocatalysts (2) are trialkyl aluminum compounds. In some embodiments, the trialkyl aluminum compounds are selected from the group consisting of Al-triethyl, Al-triisobutyl and Al-tri-n-butyl.

In some embodiments, the external electron-donors (added to the Al-alkyl compound) are made from or contain aromatic acid esters, heterocyclic compounds, and silicon compounds containing at least one Si—OR bond (where R is a hydrocarbon radical). In some embodiments, the aromatic acid esters are alkylic benzoates. In some embodiments, the heterocyclic compounds are selected from the group consisting of 2,2,6,6-tetramethylpiperidine and 2,6-diisopropylpiperidine.

In some embodiments, the silicon compounds have the formula R¹ₐR²_{b}Si(OR³)_{c}, where a and b are integer numbers from 0 to 2, c is an integer from 1 to 3 and the sum (a+b+c) is 4; R¹, R² and R³ are alkyl, cycloalkyl or aryl radicals with 1-18 carbon atoms optionally containing heteroatoms.

In some embodiments, the silicon compounds are selected from the group consisting of (tert-butyl)₂Si(OCH₃)₂, (cyclohexyl)(methyl)Si (OCH₃)₂, (phenyl)₂Si(OCH₃)₂ and (cyclopentyl)₂Si(OCH₃)₂.

In some embodiments, the previously-described 1,3-diethers are external donors. In some embodiments, when the internal donor is a 1,3-diether, the external donor is omitted.

In some embodiments, catalysts are precontacted with small quantities of olefin (prepolymerization) by maintaining the catalyst in suspension in a hydrocarbon solvent, and by polymerizing at temperatures from room temperature to 60° C., thereby producing a quantity of polymer from 0.5 to 3 times the weight of the catalyst.

In some embodiments, the precontact step takes place in liquid monomer, thereby producing a quantity of polymer up to 1000 times the weight of the catalyst.

In some embodiments, the polyolefin composition (I) also contains additives. In some embodiments, the additives are selected from the group consisting of antioxidants, light stabilizers, heat stabilizers, colorants and fillers.

In a general embodiment, a blown film is prepared from the polyolefin composition (I). In some embodiments, the blown film is used in industry packaging, consumer packaging, laminating film, barrier film, films for the packaging of medical products, and agricultural film. In some embodiments, the industry packaging is selected from the group consisting of shrink film, stretch film, stretch hoods, bag film, and container liners. In some embodiments, the consumer packaging is selected from the group consisting of packaging film for frozen products, shrink film for transport packaging, food wrap film, packaging bags, and form, fill and seal packaging film. In some embodiments, the laminating film is selected from the group consisting of laminating of aluminium or paper used for packaging for example milk or coffee. In some embodiments, the barrier film is selected from the group consisting of film made of raw materials, films used for packaging food, and films for the packaging of medical products. In some embodiments, the raw materials are selected from the group consisting of polyamides and EVOH. In some embodiments, the agricultural film is selected from the group consisting of greenhouse film, crop forcing film, silage film, and silage stretch film.

In some embodiments, the thickness of the film is equal to or lower than about 250 μm, alternatively equal to or lower than about 150 μm, alternatively from about 20 to about 250 μm, alternatively from about 20 to about 150 μm.

In some embodiments, the film is a monolayer or multilayer film.

In some embodiments, the multilayer films have at least one layer made from or containing the polyolefin composition (I). In some embodiments, at least the base layer (also called “support layer”) is made from or contains the polyolefin composition (I).

In some embodiments, the polyolefin composition (I) is present in the blown film in a weight amount of at least about 40%, based upon the total weight of the blown film, alternatively from about 40 to about 100%.

The amounts are with respect to the total weight of the film when the film is a monolayer film, or with respect to the total weight of the layer or layers containing the polyolefin composition (I) for multilayer films.

In some embodiments, the other layer(s) are made from or contain other kinds of polymers.

In some embodiments, the other layers are polymers or copolymers, and their mixtures, of CH₂═CHR olefins where R is a hydrogen atom or a C₁-C₈ alkyl radical.

In some embodiments, the other polymers are selected from the group consisting of:
(a) isotactic or mainly isotactic propylene homopolymers, and homopolymers or copolymers of ethylene;
(b) semi-crystalline copolymers of propylene with ethylene or C₄-C₁₀ α-olefins, wherein the total comonomer content ranges from about 0.05% to about 20% by weight with respect to the weight of the copolymer, or mixtures of the copolymers with isotactic or mainly isotactic propylene homopolymers;
(c) elastomeric copolymers of ethylene with propylene or a C₄-C₁₀ α-olefin, optionally containing minor quantities of a diene;
(d) heterophasic copolymers made from or containing a propylene homopolymer or a copolymer of item b), and an elastomeric fraction made from or containing a copolymer of item c); and
butene-1 homopolymers or copolymers with ethylene or other α-olefins.

In some embodiments, the other polymers are selected from the group of polyethylene consisting of HDPE, LDPE, and LLDPE. In some embodiments, the C₄-C₁₀ α-olefins for the semi-crystalline copolymers of propylene are selected from the group consisting of butene-1, hexene-1, 4-methyl-1-pentene, and octene-1. In some embodiments, the elastomeric copolymers of ethylene have the quantity of diene present in an amount from about 1% to about 10% by weight, based upon the weight of the elastomeric copolymers. In some embodiments, the diene is selected from the group consisting of butadiene, 1,4-hexadiene, 1,5-hexadiene, and ethylidene-1-norbornene. In some embodiments, the heterophasic copolymers are prepared by mixing the components in the molten state, or by sequential polymerization. In some embodiments, the heterophasic copolymers have the elastomeric fraction present in quantities from about 5% to about 90% by weight, based upon the weight of the heterophasic copolymers.

In some embodiments, the other layers are made from or contain polystyrenes, polyvynylchlorides, polyamides, polyesters and polycarbonates, copolymers of ethylene and vinyl alcohol (EVOH) and “tie layer” resins.

In some embodiments, the film undergoes a series of subsequent operations. In some embodiments, the subsequent operations are selected from the group consisting of surface embossing, by heating the surface and compressing it against an embossing roller; printing, after having made the surface ink sensitive through oxidating or ionizing treatments; coupling with fabric or film, by heating of the surfaces and compression; coextrusion with other polymeric or metallic materials; plating treatments; and application of an adhesive layer on one of the two faces of the film, thus producing an adhesive film.

In some embodiments, the film is used in goods and food packaging.

In a general embodiment, a blown film process is provided, wherein the polyolefin composition (I) is used to produce at least one layer of the film.

In some embodiments, the screw length is from about 20 to about 40 times the screw diameter, alternatively from about 25 to about 35 times the screw diameter.

In some embodiments, the barrel and die temperatures are from about 160 to about 240° C.

In some embodiments, the die temperature is from about 200 to about 240° C.

In some embodiments, film extrusion is performed in vertical upward direction.

In some embodiments, the blow-up ratio is from about 2.2 to about 4, alternatively from about 2.4 to about 3.6.

In some embodiments, the die diameter is from about 30 mm to about 2 m or higher.

In some embodiments, film cooling is performed with cooling fluids. In some embodiments, the cooling fluids are in a liquid or a gaseous state. In some embodiments, cooling is with a liquid cooling medium and water is the cooling medium. In some embodiments, cooling is with a liquid cooling medium and the extrusion direction is vertical downward. In some embodiments, cooling is with a gaseous cooling medium and air is the cooling medium. In some embodiments, the gaseous cooling medium is nitrogen. In some embodiments, cooling is with a gaseous cooling medium and the extrusion direction is vertical upward.

In some embodiments, the cooling medium temperature is from about 5 to about 20° C., alternatively from about 10 to about 20° C.

In some embodiments, the gap of the die ring (annular die gap) is equal to or less than about 3 mm, alternatively equal to or less than about 1.8 mm.

In some embodiments, the blown film has a tensile strength at yield (MD) ranging from about 3 MPa to about 20 MPa; alternatively from about 5 MPa to about 15 MPa. In some embodiments, the blown film has an elongation at yield (MD) ranging from about 20% to about 40%; alternatively from about 30% to about 35%. In some embodiments, the blown film has a tensile strength at break (MD) ranging from about 10 MPa to about 40 MPa; alternatively from about 15 MPa to about 30 MPa. In some embodiments, the blown film has an elongation at break (MD) ranging from about 500% to about 2500%; alternatively from about 800% to about 2000%.

### EXAMPLES

The various embodiments, compositions and methods as provided herein are disclosed further below in the following examples. These examples are illustrative only and not intended to limit the scope of this disclosure in any manner whatsoever.

### Example 1

Preparation of the Polyolefin Composition (I)

The solid catalyst component used in polymerization is a Ziegler-Natta catalyst component supported on magnesium chloride, containing titanium and diisobutylphthalate as internal donor.

An initial amount of microspheroidal MgCl₂.2.8C₂H₅OH was prepared according to the method described in Example 2 of U.S. Pat. No. 4,399,054, incorporated herein by reference, but operating at 3,000 rpm instead of 10,000. The adduct was then subjected to thermal dealcoholation at increasing temperatures from 30 to 130° C. under nitrogen stream until the molar alcohol content per mol of Mg was 1.16.

Into a 1000 mL four-necked round flask, purged with nitrogen, 500 mL of TiCl₄ were introduced at 0° C. While stirring, 30 grams of the microspheroidal MgCl₂.1.16C₂H₅OH adduct were added. The temperature was raised to 120° C. and kept at this temperature for 60 minutes. During the temperature increase, an amount of diisobutylphthalate was added such as to have a Mg/diisobutylphthalate molar ratio of 18. After 60 minutes, the stirring was stopped. The liquid was siphoned off. The treatment with TiCl₄ was repeated at 100° C. for 1 hour in the presence of an amount of diisobutylphthalate such as to have a Mg/diisobutylphthalate molar ratio of 27. The stirring was stopped. The liquid was siphoned off. The treatment with TiCl₄ was repeated at 100° C. for 30 min. After sedimentation and siphoning at 85° C., the solid was washed six times with anhydrous hexane (6×100 ml) at 60° C.

The solid catalyst component was contacted at 30° C. for 9 minutes with aluminum triethyl (TEAL) and dicyclopentyldimethoxysilane (DCPMS), in a TEAL/DCPMS weight ratio equal to about 15 and in such quantity that the TEAL/solid catalyst component weight ratio was equal to 4.

The catalyst system was subjected to prepolymerization by maintaining the catalyst system in suspension in liquid propylene at 50° C. for about 75 minutes.

The polymerization was carried out continuously in a series of two gas-phase reactors equipped with devices to transfer the product from the first reactor to the second one.

In the first gas phase polymerization reactor, a polyethylene with 3.4 wt. % of propylene and 5.2 wt. % of butene-1 (component A), both based on the weight of the polyethylene, was produced by feeding the prepolymerized catalyst system, hydrogen (used as molecular weight regulator), ethylene and butene-1, each in the gas state in a continuous and constant flow.

The polyethylene formed in the first reactor was continuously discharged and, after having been purged of unreacted monomers, was introduced into the second gas phase reactor in a continuous flow with quantitatively constant flows of hydrogen, ethylene and propylene in the gas state.

In the second reactor, a copolymer of ethylene with propylene made from or containing 40 wt. %, based upon the weight of the copolymer, of propylene was produced (component B). Polymerization conditions, molar ratio of the reactants and composition of the copolymers obtained are shown in Table I.

The polymer particles exiting the second reactor were subjected to a steam treatment to remove the reactive monomers and volatile substances, and then dried.

Then the polyolefin composition was mixed with a stabilizing additive composition in a twin screw extruder Berstorff ZE 25 (length/diameter ratio of screws: 33) and extruded under nitrogen atmosphere in the following conditions:
Rotation speed: 250 rpm;
Extruder output: 15 kg/hour;
Melt temperature: 280-290° C.
From the extruder, a stabilized polyolefin composition was discharged, made from or containing the following additives:
0.1% by weight of Irganox® 1010;
0.1% by weight of Irgafos® 168;
0.04% by weight of DHT-4A (hydrotalcite), weights based upon the weight of the stabilized polyolefin composition.

Irganox® 1010 is 2,2-bis[3-[,5-bis(1,1-dimethyl ethyl)-4-hydroxyphenyl)-1-oxopropoxy]methyl]-1,3-propanediyl-3,5-bis(1,1-dimethylethyl)-4-hydroxybenzene-propanoate, while Irgafos® 168 is tris(2,4-di-tert.-butylphenyl)phosphite.

TABLE I

| Example No. | | 1 |
|---|---|---|
| 1^{st} Reactor (component A) | | |
| Temperature | ° C. | 75 |
| Pressure | barg | 20 |
| H2/C2− | mol. | 0.54 |
| C2−/(C2− + C3−) | mol. | 0.98 |
| C4−/(C4− + C2−) | mol. | 0.058 |
| Split | wt % | 65 |
| Xylene soluble (XS_{A}) | wt % | 5.2 |
| MFR of A) | g/10 min. | 7.3 |
| Density of A) | g/cm³ | 0.930 |
| C3− content of A) | wt % | 3.4 |
| C4− content of A) | wt % | 5.3 |
| 2^{nd} Reactor (component B) | | |
| Temperature | ° C. | 65 |
| Pressure | barg | 20 |
| H2/C2− | mol. | 0.19 |
| H2/C3− | mol. | 0.15 |
| C2−/(C2− + C3−) | mol. | 0.45 |
| Split | wt % | 35 |
| C3− content of B) * | wt % | 40 |
| Xylene soluble of B) * (XS_{B}) | wt % | 90 |
| C3− content of A + B) | wt % | 14.5 |
| Xylene soluble of A + B) (XS) | wt % | 34.0 |
| Intrinsic Viscosity of A + B XSIV | dl/g | 2.55 |
| Tm of A) + B) | ° C. | 123.7 |
| ΔHm of A) + B) | J/gr | 87.4 |

Notes:
C3− = propylene; C2− = ethylene; C4− = butene-1; split = amount of polymer produced in the concerned reactor.
* Calculated values

TABLE II

| Example | | Ex. 1 |
|---|---|---|
| Density | g/cm³ | 0.9055 |
| MFR | g/10 min. | 2.0 |
| Flexural Modulus | MPa | 210 |
| Tensile Strength at Yield | MPa | 6.5 |
| Elongation at Yield | % | 32.8 |
| Tensile strength at break | MPa | 9.4 |
| Elongation at break | % | 550 |
| Vicat | ° C. | 78.8 |
| HdT (@ 0.455 MPa) | ° C. | 38.9 |

MD = Machine Direction
TD = Transverse Direction

Three-layer films were prepared on a Collin three-layer coextrusion line. The film of Example 1 was prepared by using the polyolefin composition (I) for the three layers.

In Comparative Example 1, the polymer material was a low density polyethylene having a density of 0.927 g/cm³ and a MFR of 0.25 g/10 min., measured according to ISO 1133 at 190° C. with a load of 2.16 kg.

The low density polyethylene is commercially available from LyondellBasell under the trademark Lupolen 3010 D.

In the Collin coextrusion line, the screw length/screw diameter ratios were 30 mm/30×D for extruders A & C while 45 mm/30×D for extruder B. No DEWS system (Internal Bubble Cooling System) was used. During the extrusion trials, the melt was extruded through an annular die with a diameter of 100 mm and a quite narrow gap (0.8 mm for the trials). At the exit from the die, the melt tube was subjected to intensive air cooling, immediately blown up to about three times the diameter of the die and stretched in the direction of the flow.

The main operating conditions were:
Barrel temperature: 200-210-220-220-220° C.;
Adaptor temperature: 220° C.;
Die temperature: 220-220-220-220-215° C.;
Blow-up ratio: 3.1;
Total throughput 13-15 kg/h.

The final film thickness of the films was approximately 100 micron, with a thickness distribution (in percentage) of 20/60/20.

The properties of the films are reported in Table III.

TABLE III

| Example | | Ex. 1 | Comp. 1 |
|---|---|---|---|
| Tensile Strength at Yield (MD) | MPa | 8.4 | 13.1 |
| Elongation at Yield (MD) | % | 30.8 | 19.1 |
| Tensile strength at break (MD) | MPa | 21.2 | 26.7 |
| Elongation at break (MD) | % | 1362 | 935 |

What is claimed is:

1. A blown film comprising:
a polyolefin composition (I) comprising:
A) from about 40 to about 75 wt. %, based upon the total weight of the polyolefin composition, of a polyethylene having a density of about 0.920 to about 0.940 g/cm³ and a fraction soluble in xylene (XS_{A}) of less than about 10 wt. %, based upon the weight of the polyethylene, the polyethylene comprising ethylene and one or more comonomers selected from α-olefins having formula CH₂═CHR, wherein R is an alkyl radical, linear or branched, having from 1 to 10 carbon atoms; and
B) from about 25 to about 60 wt. %, based upon the total weight of the polyolefin composition, of a copolymer of ethylene with one or more comonomers selected from α-olefins having formula HC₂═CHR^{I}, where R^{I} is an alkyl radical, linear or branched, having from 1 to 8 carbon atoms, comprising from about 50 to about 70 wt. %, based upon the weight of the copolymer of ethylene, of ethylene and having a fraction soluble in xylene (XS_{B}) of at least about 50 wt. %, based upon the weight of the copolymer of ethylene.

2. The blown film of claim 1 being a monolayer film or a multilayer film.

3. The blown film of claim 1 having thickness equal to or lower than about 250 μm.

4. The blown film of claim 1, wherein the composition (I) has a flexural modulus of less than about 260 MPa as measured according to ISO 178.

5. The blown film of claim 1, wherein polyethylene component A) has a solubility in xylene (XS_{A}) at 25° C. of less than about 8 wt. %, based upon the weight of polyethylene component A).

6. The blown film of claim 1, wherein the ethylene copolymer of component B) comprises from about 35 to about 45 wt. % of propylene, based upon the weight of the ethylene copolymer of component B).

7. The blown film of claim 1, wherein the ethylene copolymer of component B) has a fraction soluble in xylene (XS_{B}) of from about 70 to about 95 wt. %, based upon the weight of the ethylene copolymer of component B).

8. A packaging comprising
a blown film comprising
(I) a polyolefin composition (I) comprising
A) from about 40 to about 75 wt. %, based upon the total weight of the polyolefin composition, of a polyethylene having a density of about 0.920 to about 0.940 g/cm³ and a fraction soluble in xylene (XS_{A}) of less than about 10 wt. %, based upon the weight of the polyethylene, the polyethylene comprising ethylene and one or more comonomers selected from α-olefins having formula CH₂═CHR, wherein R is an alkyl radical, linear or branched, having from 1 to 10 carbon atoms; and
B) from about 25 to about 60 wt. %, based upon the total weight of the polyolefin composition, of a copolymer of ethylene with one or more comonomers selected from α-olefins having formula HC₂═CHR^{I}, where R^{I} is an alkyl radical, linear or branched, having from 1 to 8 carbon atoms, comprising from about 50 to about 70 wt. %, based upon the weight of the copolymer of ethylene, of ethylene and having a fraction soluble in xylene (XS_{B}) of at least about 50 wt. %, based upon the weight of the copolymer of ethylene.

9. A blown film process comprising the step:
producing at least one film layer comprising
(I) a polyolefin composition (I) comprising
A) from about 40 to about 75 wt. %, based upon the total weight of the polyolefin composition, of a polyethylene having a density of about 0.920 to about 0.940 g/cm³ and a fraction soluble in xylene (XS_{A}) of less than about 10 wt. %, based upon the weight of the polyethylene, the polyethylene comprising ethylene and one or more comonomers selected from α-olefins having formula CH₂═CHR, wherein R is an alkyl radical, linear or branched, having from 1 to 10 carbon atoms; and
B) from about 25 to about 60 wt. %, based upon the total weight of the polyolefin composition, of a copolymer of ethylene with one or more comonomers selected from α-olefins having formula HC₂═CHR^{I}, where R^{I} is an alkyl radical, linear or branched, having from 1 to 8 carbon atoms, comprising from about 50 to about 70 wt. %, based upon the weight of the copolymer of ethylene, of ethylene and having a fraction soluble in xylene (XS_{B}) of at least about 50 wt. %, based upon the weight of the copolymer of ethylene.

10. The blown film process of claim 9, carried out under the following conditions:
screw length from about 20 to about 40 times the screw diameter;
barrel and die temperatures from about 160 to about 240° C.;
annular die gap equal to or less than about 3 mm; and
blow-up ratio from about 2.2 to about 4.

11. The packaging according to claim 8 selected from the group consisting of goods packaging and food packaging.
